(19) United States
(12) Patent Application Publication
(10) Pub. No.: US 2026/0058346 A1
(43) Pub. Date: Feb. 26, 2026

(54) RAT-RACE COUPLER

(71) Applicant: TMY Technology Inc., New Taipei City (TW)

(72) Inventor: Chun-Cheng Chan, New Taipei City (TW)

(73) Assignee: TMY Technology Inc., New Taipei City (TW)

(21) Appl. No.: 19/260,317

(22) Filed: Jul. 4, 2025

(30) Foreign Application Priority Data
Aug. 20, 2024 (TW) 113131213
Oct. 18, 2024 (TW) 113139692

(51) Int. Cl. H01P 1/02

(52) U.S. Cl. CPC H01P 1/02

(57) ABSTRACT

The disclosure provided a rat-race coupler, including an annular-shaped conductor and a first bandwidth adjustment part. The annular-shaped conductor includes a first strip-shaped conductor, a second strip-shaped conductor, a third strip-shaped conductor, and a fourth strip-shaped conductor. The first strip-shaped conductor has a first terminal and a second terminal. The second strip-shaped conductor has a third terminal and a fourth terminal. The first terminal is connected to the third terminal through the third strip-shaped conductor, the second terminal is connected to the fourth terminal through the fourth strip-shaped conductor. The first bandwidth adjustment part includes a fifth strip-shaped conductor, a sixth strip-shaped conductor, and a seventh strip-shaped conductor. The seventh strip-shaped conductor has a fifth terminal and a sixth terminal. The fifth terminal is connected to the third terminal through the fifth strip-shaped conductor, the sixth terminal is connected to the fourth terminal through the sixth strip-shaped conductor.

### CROSS-REFERENCE TO RELATED APPLICATION

This application claims the priority benefit of Taiwan application serial no. 113131213, filed on Aug. 20, 2024, and Taiwan application serial no. 113139692, filed on Oct. 18, 2024. The entirety of each of the above-mentioned patent applications is hereby incorporated by reference herein and made a part of this specification.

### BACKGROUND

### Technical Field

The disclosure relates to an electrical component, and in particular to a rat-race coupler.

### Description of Related Art

Rat-race coupler is also referred to as Balun or hybrid ring coupler. The ideal rat-race coupler may be configured to combine two input signals into one output signal or to split one input signal into two output signals. However, the output of the currently used rat-race coupler usually exhibits phase errors. Therefore, how to improve the phase error of the rat-race coupler is one of the important topics in this field.

### SUMMARY

The disclosure provides a rat-race coupler that can reduce the phase error of two output signals of the rat-race coupler.

A rat-race coupler is provided in an embodiment of the disclosure. The rat-race coupler includes an annular-shaped conductor, a first bandwidth adjustment part, a first port, a second port and a third port. The annular-shaped conductor includes a first strip-shaped conductor, a second strip-shaped conductor, a third strip-shaped conductor and a fourth strip-shaped conductor. The first strip-shaped conductor has a first terminal and a second terminal. The second strip-shaped conductor has a third terminal and a fourth terminal. The first terminal is connected to the third terminal through the third strip-shaped conductor. The second terminal is connected to the fourth terminal through the fourth strip-shaped conductor. The first bandwidth adjustment part includes a fifth strip-shaped conductor, a sixth strip-shaped conductor and a seventh strip-shaped conductor. The seventh strip-shaped conductor has a fifth terminal and a sixth terminal. The fifth terminal is connected to the third terminal through the fifth strip-shaped conductor. The sixth terminal is connected to the fourth terminal through the sixth strip-shaped conductor. The first port is connected to the fifth terminal. The second port is connected to the first terminal. The third port is connected to the second terminal. The electrical length from the first terminal through the first strip-shaped conductor to the second terminal, the electrical length from the third terminal through the second strip-shaped conductor to the fourth terminal, and the electrical length from the fifth terminal through the seventh strip-shaped conductor to the sixth terminal are both ½. The electrical length from the first terminal through the third strip-shaped conductor to the third terminal, and the electrical length from the second terminal through the fourth strip-shaped conductor to the fourth terminal are both ¼. The electrical length from the third terminal through the fifth strip-shaped conductor to the fifth terminal, and the electrical length from the fourth terminal through the sixth strip-shaped conductor to the sixth terminal are both n/4, wherein n is a positive integer.

In an embodiment of the disclosure, the above n is an even number.

In an embodiment of the disclosure, the rat-race coupler further includes a fourth port. The fourth port is connected to a center of the first strip-shaped conductor.

In an embodiment of the disclosure, the first port, the second port, and the third port are used to connect to at least one external system, wherein the at least one external system has a load impedance. The impedance of the second strip-shaped conductor is 1.2 times the load impedance. The impedance of the seventh strip-shaped conductor is 0.8 times the load impedance. The impedance of the fifth strip-shaped conductor and the impedance of the sixth strip-shaped conductor are both 2.8 times the load impedance.

In an embodiment of the disclosure, the rat-race coupler further includes a second bandwidth adjustment part. The second bandwidth adjustment part includes an eighth strip-shaped conductor, a ninth strip-shaped conductor and a tenth strip-shaped conductor. The tenth strip-shaped conductor has a seventh terminal and an eighth terminal. The seventh terminal is connected to the fifth terminal through the eighth strip-shaped conductor. The eighth terminal is connected to the sixth terminal through the ninth strip-shaped conductor. The first port is connected to the seventh terminal, and is connected to the fifth terminal through the eighth strip-shaped conductor.

In an embodiment of the disclosure, the first port, the second port, and the third port are used to connect to at least one external system, the at least one external system has a load impedance. The impedance of the tenth strip-shaped conductor is 0.8 times the load impedance. The impedance of the seventh strip-shaped conductor is 1.4 times the load impedance. The impedance of the sixth strip-shaped conductor, the impedance of the eighth strip-shaped conductor, and the impedance of the ninth strip-shaped conductor are both 2.8 times the load impedance.

In an embodiment of the disclosure, the electrical length from the seventh terminal through the tenth strip-shaped conductor to the eighth terminal is ½. The electrical length from the fifth terminal through the eighth strip-shaped conductor to the seventh terminal and the electrical length from the sixth terminal through the ninth strip-shaped conductor to the eighth terminal are both m/2, wherein m is a positive integer.

In an embodiment of the disclosure, above m is an even number.

In an embodiment of the disclosure, wherein m is equal to n.

In an embodiment of the disclosure, the rat-race coupler further includes a third bandwidth adjustment part. The third bandwidth adjustment part includes an eleventh strip-shaped conductor, a twelfth strip-shaped conductor, and a thirteenth strip-shaped conductor. The thirteenth strip-shaped conductor has a ninth terminal and a tenth terminal. The ninth terminal is connected to the seventh terminal through the eleventh strip-shaped conductor. The tenth terminal is connected to the eighth terminal through the twelfth strip-shaped conductor. The first port is connected to the ninth terminal, and is connected to the fifth terminal through the eleventh strip-shaped conductor and the eighth strip-shaped conductor.

In an embodiment of the disclosure, the impedance of the seventh strip-shaped conductor and the impedance of the tenth strip-shaped conductor are both 1.4 times the load impedance. The impedance of the thirteenth strip-shaped conductor is 0.8 times the load impedance. The impedance of the fifth strip-shaped conductor, the impedance of the sixth strip-shaped conductor, the impedance of the eighth strip-shaped conductor, the impedance of the ninth strip-shaped conductor, the impedance of the eleventh strip-shaped conductor, and the impedance of the twelfth strip-shaped conductor are both 2.8 times the load impedance.

In an embodiment of the disclosure, the electrical length from the ninth terminal through the thirteenth strip-shaped conductor to the tenth terminal is ½. The electrical length from the seventh terminal through the eleventh strip-shaped conductor to the ninth terminal and the electrical length from the eighth terminal through the twelfth strip-shaped conductor to the tenth terminal are both k/2, wherein k is a positive integer.

In an embodiment of the disclosure, above k is an even number.

In an embodiment of the disclosure, wherein k, m and n are equal.

Based on the above, the disclosure uses the strip-shaped conductor with the specific length to form the bandwidth adjustment part, and combines the annular-shaped conductor with one or more bandwidth adjustment parts to form a multi-order rat-race coupler. The rat-race coupler can reduce the phase error of the two output signals of the rat-race coupler.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic diagram of a rat-race coupler.

FIG. 2A and FIG. 2B are schematic diagrams of a second-order rat-race coupler according to an embodiment of the disclosure.

FIG. 3 is a schematic diagram of a third-order rat-race coupler according to an embodiment of the disclosure.

FIG. 4 is a schematic diagram of a fourth-order rat-race coupler according to an embodiment of the disclosure.

FIG. 5 to FIG. 8 are simulation diagrams of an S parameter of the second-order rat-race coupler according to an embodiment of the disclosure.

FIG. 9 to FIG. 12 are simulation diagrams of the S parameter of the third-order rat-race coupler according to an embodiment of the disclosure.

FIG. 13 to FIG. 16 are simulation diagrams of the S parameter of the fourth-order rat-race coupler according to an embodiment of the disclosure.

FIG. 17 is a simulation diagram of the S parameter of a seventh-order rat-race coupler according to an embodiment of the disclosure.

FIG. 18 to FIG. 19 are simulation diagrams of the S parameter of the third-order rat-race coupler according to an embodiment of the disclosure.

FIG. 20 is a simulation diagram of the S parameter of the third-order rat-race coupler according to an embodiment of the disclosure.

### DESCRIPTION OF THE EMBODIMENTS

Reference now is made in detail to exemplary embodiments of the disclosure, examples of which are illustrated in the accompanying drawings. Wherever possible, the same reference numerals are used in the drawings and the description to refer to the same or like parts.

In the following embodiments, two elements that are “connected” to each other are directly connected to each other, and two elements that are “electrically connected” to each other are directly or indirectly (for example, two elements are connected to each other through a third element. connection) connected to each other.

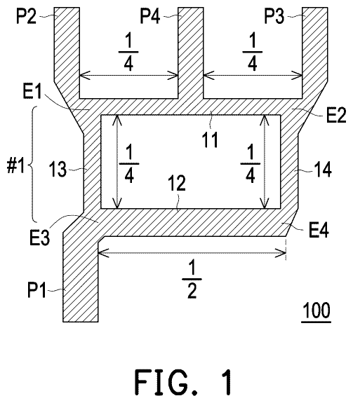

FIG. 1 is a schematic diagram of a rat-race coupler 100. The rat-race coupler 100 is a structure formed by a single annular-shaped conductor #1.Accordingly, the rat-race coupler 100 may be referred to as a first-order rat-race coupler, a Balun, or a hybrid ring coupler. The annular-shaped conductor #1 is, for example, a circle or parallelogram formed by the strip-shaped conductor 11, the strip-shaped conductor 12, the strip-shaped conductor 13, and the strip-shaped conductor 14, in which the strip-shaped conductor 12 is the opposite side of the strip-shaped conductor 11, and the strip-shaped conductor 14 is the opposite side of the strip-shaped conductor 13. Further explanation, the strip-shaped conductor 11 has the terminal E1 and the terminal E2. The strip-shaped conductor 12 has the terminal E3 and the terminal E4. The terminal E1 may be connected to the terminal E3 through the strip-shaped conductor 13. The terminal E2 may be connected to the terminal E4 through the strip-shaped conductor 14. It should be noted that the rat-race coupler in this disclosure may be implemented by wave-guide, micro-strip line, co-axial cable, or any other electronic component suitable for transmitting microwave and/or millimeter-wave signal.

The rat-race coupler 100 may include four ports made of conductors, including a port P1, a port P2, a port P3, and a port P4. The port P1 may be connected to the terminal E3, the port P2 and the port P3 may be respectively connected to the terminal E1 and the terminal E2, and the port P4 may be connected to the center of the strip-shaped conductor 11. The electrical length from the terminal E1 to the terminal E2 through the strip-shaped conductor 11 or the electrical length from the terminal E3 to the terminal E4 through the strip-shaped conductor 12 may be ½. The electrical length from the terminal E1 to the terminal E3 through the strip-shaped conductor 13 or the electrical length from the terminal E2 to the terminal E4 through the strip-shaped conductor 14 may be ¼. For the embodiments of the disclosure, the electrical length is defined to be a ratio of a physical length of the signal path (e.g., conductor) and the wavelength λ corresponding the center operating frequency of the rat race coupler 100. The wavelength mentioned is not the vacuum wavelength but the characteristic wavelength of the signal in the signal path/waveguide structure. The electrical length between the port P1 and the port P2 may be equal to ¼ (for example, the electrical length from the terminal E1 to the terminal E3 through the strip-shaped conductor 13). In other words, a signal with this operating frequency transmitted from the port P1 to the port P2 experiences exactly one-quarter wavelength. The electrical length between the port P1 and the port P3 may be equal to ¾ (for example, the electrical length from the terminal E3 to the terminal E4 through of the strip-shaped conductor 12 plus the electrical length from the terminal E2 to the terminal E4 through the strip-shaped conductor 14). The electrical length between the port P1 and the port P4 may be equal to ½ (for example, the electrical length from the terminal E1 to the terminal E3 through the strip-shaped conductor 13 plus half the electrical length from the terminal E1 to the terminal E2 through the strip-shaped conductor 11). The electrical length between the port P2 and the port P3 may be equal to ½ (for example, the electrical length from the terminal E1 to the terminal E2 through the strip-shaped conductor 11). The electrical length between the port P2 and the port P4 may be equal to ¼ (for example, half the electrical length from the terminal E1 to the terminal E2 through the strip-shaped conductor 11). The electrical length between the port P3 and the port P4 may be equal to ¼ (for example, half the electrical length from the terminal E1 to the terminal E2 through the strip-shaped conductor 11).

The rat-race coupler 100 may be configured to split one input signal into two output signals. For example, when an input signal is input from the port P1 to the rat-race coupler 100, the rat-race coupler 100 may divide the input signal into two output signals and output the two signals with the same amplitude through the port P2 and the port P3 respectively, in which there is a phase difference of 180 degrees between the output signal output from the port P2 and the output signal output from the port P3, and the port P4 is isolated and no signal is output from the port P4.

The rat-race coupler 100 may be configured to combine two input signals into one output signal. For example, when two input signals are input into the rat-race coupler 100 from the port P2 and the port P3 respectively, the rat-race coupler 100 may combine the two input signals into one output signal. The port P4 may be used as a sum port or a 2 port, and the output signal output by the port P4 is the sum of the two input signals. The port P1 may be used as a Δ port, and the output signal output by the port P1 is the difference between the two input signals.

The rat-race coupler 100 may be connected to loads via the port P1, the port P2, the port P3, or the port P4. In one implementation, the port P1, the port P2, the port P3, or the port P4 may be used to connect to at least one external system (not shown), and the external system has a load impedance. The impedances of the strip-shaped conductor 11, the strip-shaped conductor 12, the strip-shaped conductor 13, or the strip-shaped conductor 14 in the annular-shaped conductor #1 may be 1.2 times the load impedance. For example, if the load impedance is 50 Ohms, then the impedance of the annular-shaped conductor #1 may be 60 Ohms.

In an embodiment, one or more additional bandwidth adjustment parts may be added to the structure of the rat-race coupler 100 to form an A-order rat-race coupler including 1 annular-shaped conductor and (A-1) bandwidth adjustment parts, in which A is any positive integer. “a” is defined as the index of the order of the annular-shaped conductor or the bandwidth adjustment part in the A-order rat-race coupler and a=1, 2, . . . , A. For example, a=1 is used to represent the first element of the A-order rat-race coupler, and the element is an annular-shaped conductor (that is, the annular-shaped conductor #1 directly connected to the port P2, the port P3, or the port P4), a=2 is used to represent the second element of the A-order rat-race coupler, and the element is the bandwidth adjustment part (that is, directly connected to the annular-shaped conductor #1 and electrically connected to a bandwidth adjustment part #2 of the port P2, the port P3, or the port P4), and a=A is used to represent the A-th element of the A-order rat-race coupler, and the element is the bandwidth adjustment part (that is, a bandwidth adjustment part #A directly connected to the port P1).

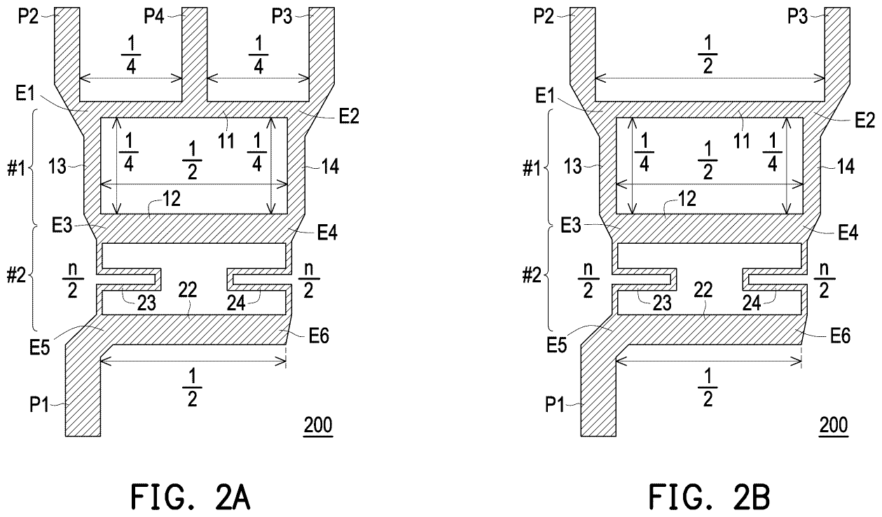

The phase error caused by the A-order rat-race coupler may be smaller than the phase error caused by the rat-race coupler 100. For example, an additional bandwidth adjustment part may be added to the structure of the rat-race coupler 100 to form a second-order rat-race coupler, as shown in FIG. 2A.

FIG. 2A is a schematic diagram of a second-order rat-race coupler 200 according to an embodiment of the disclosure. Compared with the structure of the rat-race coupler 100 shown in FIG. 1, the rat-race coupler 200 may further include the additional bandwidth adjustment part #2. The bandwidth adjustment part #2 is, for example, a U-shaped conductor formed by the strip-shaped conductor 22, the strip-shaped conductor 23, and the strip-shaped conductor 24, in which the strip-shaped conductor 23 is the opposite side of the strip-shaped conductor 24. The strip-shaped conductor 24 has the terminal E5 and the terminal E6. The terminal E5 may be connected to the terminal E3 through the strip-shaped conductor 23. The terminal E6 may be connected to the terminal E4 through the strip-shaped conductor 24.

The port P1 may be connected to the terminal E5, the port P2 may be connected to the terminal E1, the port P3 may be connected to the terminal E2, and the port P4 may be connected to the center of the strip-shaped conductor 11. The port P2, the port P3, or the port P4 may be electrically connected to the strip-shaped conductor 23 and the strip-shaped conductor 24 of the bandwidth adjustment part #2 through the annular-shaped conductor #1. The electrical length from the terminal E5 to the terminal E6 through the strip-shaped conductor 22 may be ½, and the electrical length from the terminal E3 to the terminal E5 through the strip-shaped conductor 23 or the electrical length from the terminal E4 to the terminal E6 through the strip-shaped conductor 24 may be n/2. When n is a positive integer, that is, the electrical length of the strip-shaped conductor 23 (for example, from the terminal E3 to the terminal E5 through the strip-shaped conductor 23) and the electrical length of the strip-shaped conductor 24 (for example, from the terminal E4 to the terminal E6 through the strip-shaped conductor 24) reach an integer multiple of half wavelength λ/2, the rat-race coupler 200 may have better performance. In order to make the electrical length of the strip-shaped conductor 23 or the strip-shaped conductor 24 reach n/2, the strip-shaped conductor 23 or the strip-shaped conductor 24 may be a conductor with a meander structure.

The rat-race coupler 200 is a second-order rat-race coupler (that is, A=2) formed by adding an additional bandwidth adjustment part #2 to the structure of the rat-race coupler 100. The electrical length between the port P1 and the port P2 may be equal to (2n+1)/4 (for example, the electrical length from the terminal E1 to the terminal E3 plus the electrical length from the terminal E3 to the terminal E5). The electrical length between the port P1 and the port P3 may be equal to (2n+3)/4 (for example, the electrical length from the terminal E5 to the terminal E6 plus the electrical length from the terminal E2 to the terminal E4 and the electrical length from the terminal E4 to the terminal E6). The electrical length between the port P1 and the port P4 may be equal to (n+1)/2 (for example, the electrical length from the terminal E1 to the terminal E3 plus the electrical length from the terminal E3 to the terminal E5 and half the electrical length from the terminal E1 to the terminal E2). The electrical length between the port P2 and the port P3 may be equal to ½ (for example, the electrical length from the terminal E1 to the terminal E2). The electrical length between the port P2 and the port P4 may be equal to ¼ (for example, half the electrical length from the terminal E1 to the terminal E2). The electrical length between the port P3 and the port P4 may be equal to ¼ (for example, half the electrical length from the terminal E1 to the terminal E2).

The rat-race coupler 200 may be connected to loads via the port P1, the port P2, the port P3, or the port P4. In one implementation, the port P1, the port P2, the port P3, or the port P4 may be used to connect to at least one external system (not shown), and the external system has a load impedance. The impedances of the strip-shaped conductor 11, the strip-shaped conductor 12, the strip-shaped conductor 13, or the strip-shaped conductor 14 in the annular-shaped conductor #1 may be 1.2 times the load impedance. The impedance of the strip-shaped conductor 22 of the bandwidth adjustment part #2 may be 0.8 times the load impedance. The impedance of the strip-shaped conductor 23 or the strip-shaped conductor 24 of the bandwidth adjustment part #2 may be 2.8 times the load impedance.

For example, if the load impedance is 50 Ohms, then the impedance of the annular-shaped conductor #1 may be 60 Ohms, the impedance of the strip-shaped conductor 22 may be 40 Ohms, and the impedance of the strip-shaped conductor 23 or the strip-shaped conductor 24 may be 140 Ohms.

In an embodiment, the rat-race coupler 200 may not have the port P4 or the port P4 of the rat-race coupler 200 may not be connected to any load (for example, the port P4 may not be connected to the external system), as shown in FIG. 2B. When an input signal is input from the port P1 to the rat-race coupler 200, the rat-race coupler 200 may divide the input signal into two output signals and output the two output signals with the same amplitude through the port P2 and the port P3 respectively, in which there is a phase difference of 180 degrees between the output signal output from the port P2 and the output signal output from the port P3. On the other hand, when two input signals are input into the rat-race coupler 200 from the port P2 and the port P3 respectively, the port P1 may be used as the Δ port, and the output signal output by the port P1 is the difference between the two input signals.

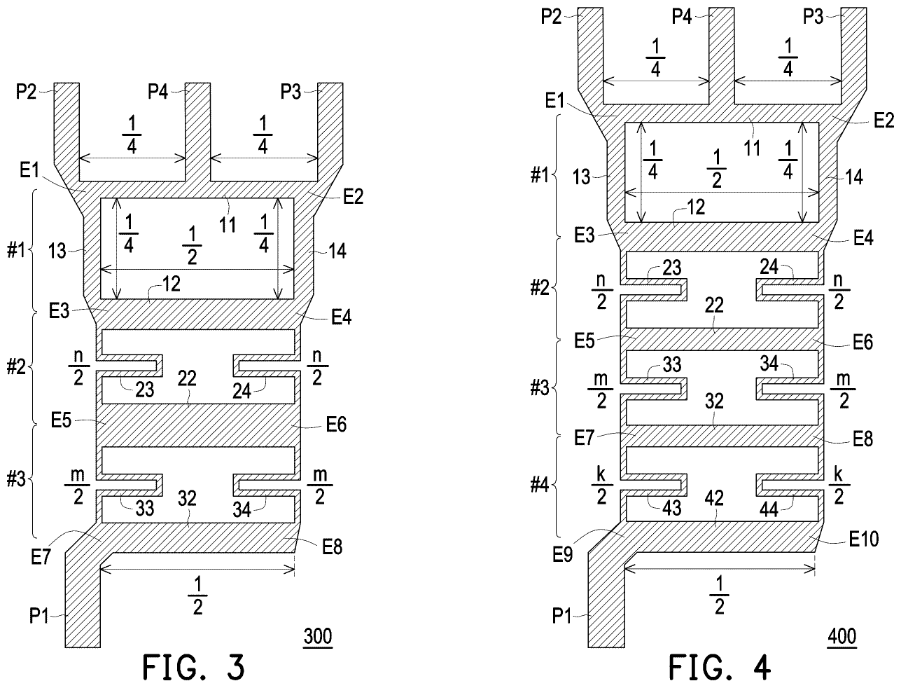

An additional bandwidth adjustment part may be added to the structure of the rat-race coupler 200 to form a third-order rat-race coupler, as shown in FIG. 3. FIG. 3 is a schematic diagram of a third-order rat-race coupler 300 according to an embodiment of the disclosure. Compared with the structure of the rat-race coupler 200 shown in FIG. 2A, the rat-race coupler 300 may further include a bandwidth adjustment part #3.

The bandwidth adjustment part #3 is, for example, a U-shaped conductor formed by the strip-shaped conductor 32, the strip-shaped conductor 33, and the strip-shaped conductor 34, in which the strip-shaped conductor 34 is the opposite side of the strip-shaped conductor 33. The strip-shaped conductor 32 has the terminal E7 and the terminal E8. The terminal E7 may be connected to the terminal E5 through the strip-shaped conductor 33. The terminal E8 may be connected to the terminal E6 through the strip-shaped conductor 34.

The port P1 may be connected to the terminal E7, and may be connected to the terminal E5 through the strip-shaped conductor 33. The port P2 and the port P3 may be respectively connected to the terminal E1 and the terminal E2, and the port P4 may be connected to the center of the strip-shaped conductor 11. The port P1 may be electrically connected to the strip-shaped conductor 22 of the bandwidth adjustment part #2 through the bandwidth adjustment part #3, and the port P2, the port P3, or the port P4 may be electrically connected to the strip-shaped conductor 33 and the strip-shaped conductor 34 of the bandwidth adjustment part #3 through the annular-shaped conductor #1 and the bandwidth adjustment part #2. The electrical length from the terminal E7 to the terminal E8 through the strip-shaped conductor 32 may be ½, and the electrical length from the terminal E5 to the terminal E7 through the strip-shaped conductor 33 or the electrical length from the terminal E6 to the terminal E8 through strip-shaped conductor 34 may be m/2. When m is a positive integer, that is, the electrical length of the strip-shaped conductor 33 (for example, from the terminal E5 to the terminal E7 through the strip-shaped conductor 33) and the electrical length of the strip-shaped conductor 34 (for example, from the terminal E6 to the terminal E8 through the strip-shaped conductor 34) reach an integer multiple of half wavelength λ/2, the rat-race coupler 300 may have better performance. In order to make the electrical length of the strip-shaped conductor 33 or the strip-shaped conductor 34 reach m/2, the strip-shaped conductor 33 or the strip-shaped conductor 34 may be a conductor with a meander structure.

The rat-race coupler 300 is a third-order rat-race coupler (that is, A=3) formed by adding the two additional bandwidth adjustment part #2 and bandwidth adjustment part #3 to the structure of the rat-race coupler 100. The electrical length between the port P1 and the port P2 may be equal to (2n+2m+1)/4 (for example, the electrical length from the terminal E1 to the terminal E3 plus the electrical length from the terminal E3 to the terminal E5 plus the electrical length from the terminal E5 to the terminal E7). The electrical length between the port P1 and the port P3 may be equal to (2m+2n+3)/4 (for example, the electrical length from the terminal E7 to the terminal E8 plus the electrical length from the terminal E2 to the terminal E4, the electrical length from the terminal E4 to the terminal E6, and the electrical length from the terminal E6 to the terminal E8). The electrical length between the port P1 and the port P4 may be equal to (m+n+1)/2 (for example, the electrical length from the terminal E1 to the terminal E3 plus the electrical length from the terminal E3 to the terminal E5, the electrical length from the terminal E5 to the terminal E7, and half the electrical length from the terminal E1 to the terminal E2). The electrical length between the port P2 and the port P3 may be equal to ½ (for example, the electrical length from the terminal E1 to the terminal E2). The electrical length between the port P2 and the port P4 may be equal to ¼ (for example, half the electrical length from the terminal E1 to the terminal E2). The electrical length between the port P3 and the port P4 may be equal to ¼ (for example, half the electrical length from the terminal E1 to the terminal E2).

The rat-race coupler 300 may be connected to loads via the port P1, the port P2, the port P3, or the port P4. In one implementation, the port P1, the port P2, the port P3, or the port P4 may be used to connect to at least one external system (not shown), and the external system has a load impedance. The impedances of the strip-shaped conductor 11, the strip-shaped conductor 12, the strip-shaped conductor 13, or the strip-shaped conductor 14 in the annular-shaped conductor #1 may be 1.2 times the load impedance. The impedance of the strip-shaped conductor 22 of the bandwidth adjustment part #2 may be 0.8 times the load impedance. The impedance of the strip-shaped conductor 23 or the strip-shaped conductor 24 of the bandwidth adjustment part #2 may be 2.8 times the load impedance. The impedance of the strip-shaped conductor 32 of the bandwidth adjustment part #3 may be 1.4 times the load impedance. The impedance of the strip-shaped conductor 33 or the strip-shaped conductor 34 of the bandwidth adjustment part #3 may be 2.8 times the load impedance.

For example, if the load impedance is 50 Ohms, then the impedance of the annular-shaped conductor #1 may be 60 Ohms, the impedance of the strip-shaped conductor 22 may be 40 Ohms, the impedance of the strip-shaped conductor 23 or the strip-shaped conductor 24 may be 140 Ohms, the impedance of the strip-shaped conductor 32 may be 70 Ohms, and the impedance of the strip-shaped conductor 33 or the strip-shaped conductor 34 may be 140 Ohms.

In an embodiment, the rat-race coupler 300 may not have the port P4 or the port P4 of the rat-race coupler 300 may not be connected to any load (for example, the port P4 may not be connected to the external system).

An additional bandwidth adjustment part may be added to the structure of the rat-race coupler 300 to form a fourth-order rat-race coupler, as shown in FIG. 4. FIG. 4 is a schematic diagram of a fourth-order rat-race coupler 400 according to an embodiment of the disclosure. Compared with the structure of the rat-race coupler 300 shown in FIG. 3, the rat-race coupler 400 may further include a bandwidth adjustment part #4.

The bandwidth adjustment part #4 is, for example, a U-shaped conductor formed by the strip-shaped conductor 42, the strip-shaped conductor 43, and the strip-shaped conductor 44, in which the strip-shaped conductor 44 is the opposite side of the strip-shaped conductor 43. The strip-shaped conductor 42 has the terminal E9 and the terminal E10. The terminal E9 may be connected to the terminal E7 through the strip-shaped conductor 43. The terminal E10 may be connected to the terminal E8 through the strip-shaped conductor 44.

The port P1 may be connected to terminal E9, and may be connected to the terminal E5 through the strip-shaped conductor 43 and the strip-shaped conductor 33. The port P2 and the port P3 may be respectively connected to the terminal E1 and the terminal E2, and the port P4 may be connected to the center of the strip-shaped conductor 11. The port P1 may be electrically connected to the strip-shaped conductor 32 of the bandwidth adjustment part #3 through the bandwidth adjustment part #4, and the port P2, the port P3, or the port P4 may be electrically connected to the strip-shaped conductor 43 and the strip-shaped conductor 44 of the bandwidth adjustment part #4 through the annular-shaped conductor #1, the bandwidth adjustment part #2, and the bandwidth adjustment part #3. The electrical length from the terminal E9 to the terminal E10 through the strip-shaped conductor 42 may be ½. The electrical length from the terminal E7 to the terminal E9 through the strip-shaped conductor 43 or the electrical length from the terminal E8 to the terminal E10 through strip-shaped conductor 44 may be k/2. When k is a positive integer, that is, the electrical length of the strip-shaped conductor 43 (for example, from the terminal E7 to the terminal E9 through the strip-shaped conductor 43) and the electrical length of the strip-shaped conductor 44 (for example, from the terminal E8 to the terminal E10 through the strip-shaped conductor 44) reach an integer multiple of half wavelength λ/2, the rat-race coupler 400 may have better performance. In order to make the electrical length of the strip-shaped conductor 43 or the strip-shaped conductor 44 reach k/2, the strip-shaped conductor 43 or the strip-shaped conductor 44 may be a conductor with a meander structure.

The rat-race coupler 400 a fourth-order rat-race coupler (that is, A=4) formed by adding the three additional bandwidth adjustment parts #2, bandwidth adjustment part #3, and bandwidth adjustment part #4 to the structure of the rat-race coupler 100. The electrical length between the port P1 and the port P2 may be equal to (2n+2m+2k+1)/4 (for example, the electrical length from the terminal E1 to the terminal E3 plus the electrical length from the terminal E3 to the terminal E5 plus the electrical length from the terminal E5 to the terminal E7 plus the electrical length from the terminal E7 to the terminal E9). The electrical length between the port P1 and the port P3 may be equal to (2n+2m+2k+3)/4 (for example, the electrical length from the terminal E9 to the terminal E10 plus the electrical length from the terminal E2 to the terminal E4, the electrical length from the terminal E4 to the terminal E6, the electrical length from the terminal E6 to the terminal E8, and the electrical length from the terminal E8 to the terminal E10). The electrical length between the port P1 and the port P4 may be equal to (n+m+k+1)/2 (for example, the electrical length from the terminal E1 to the terminal E3 plus the electrical length from the terminal E3 to the terminal E5 plus the electrical length from the terminal E5 to the terminal E7 plus the electrical length from the terminal E7 to the terminal E9, and half the electrical length from the terminal E1 to the terminal E2). The electrical length between the port P2 and the port P3 may be equal to ½ (for example, the electrical length from the terminal E1 to the terminal E2). The electrical length between the port P2 and the port P4 may be equal to ¼ (for example, half the electrical length from the terminal E1 to the terminal E2). The electrical length between the port P3 and the port P4 may be equal to ¼ (for example, half the electrical length from the terminal E1 to the terminal E2).

It is worth noting that the A-order rat-race coupler of the disclosure may exceed four orders. For example, one or more additional bandwidth adjustment parts #b (b is a positive integer greater than 4) may be disposed between the bandwidth adjustment part #4 and the port P1 and be connected to the bandwidth adjustment part #4 and the port P1, in which the one or more additional bandwidth adjustment parts #b have the same structure or impedance as the bandwidth adjustment part #4, and the manner of the one or more additional bandwidth adjustment parts #b being connected to the bandwidth adjustment part #4 may be the same as the manner of the bandwidth adjustment part #4 being connected to the bandwidth adjustment part #3.

The rat-race coupler 400 may be connected to loads via the port P1, the port P2, the port P3, or the port P4. In one implementation, the port P1, the port P2, the port P3, or the port P4 may be used to connect to at least one external system (not shown), and the external system has a load impedance. The impedances of the strip-shaped conductor 11, the strip-shaped conductor 12, the strip-shaped conductor 13, or the strip-shaped conductor 14 in the annular-shaped conductor #1 may be 1.2 times the load impedance. The impedance of the strip-shaped conductor 22 of the bandwidth adjustment part #2 may be 0.8 times the load impedance. The impedance of the strip-shaped conductor 23 or the strip-shaped conductor 24 of the bandwidth adjustment part #2 may be 2.8 times the load impedance. The impedance of the strip-shaped conductor 32 of the bandwidth adjustment part #3 may be 1.4 times the load impedance. The impedance of the strip-shaped conductor 33 or the strip-shaped conductor 34 of the bandwidth adjustment part #3 may be 2.8 times the load impedance. The impedance of the strip-shaped conductor 42 of the bandwidth adjustment part #4 (or the bandwidth adjustment part #b) may be 1.4 times the load impedance. The impedance of the strip-shaped conductor 43 or the strip-shaped conductor 44 of the bandwidth adjustment part #4 (or the bandwidth adjustment part #b) may be 2.8 times the load impedance.

For example, if the load impedance is 50 Ohms, then the impedance of the bandwidth adjustment part #1 may be 60 Ohms, the impedance of the strip-shaped conductor 22 may be 40 Ohms, the impedance of the strip-shaped conductor 23 or the strip-shaped conductor 24 may be 140 Ohms, the impedance of the strip-shaped conductor 32 may be 70 Ohms, and the impedance of the strip-shaped conductor 33 or the strip-shaped conductor 34 may be 140 Ohms. The impedance of the strip-shaped conductor 42 may be 70 Ohms. The impedance of the strip-shaped conductor 43 or the strip-shaped conductor 44 may be 140 Ohms.

In an embodiment, rat-race coupler 400 may not have the port P4 or the port P4 of the rat-race coupler 400 may not be connected to any load (for example, the port P4 may not be connected to the external system).

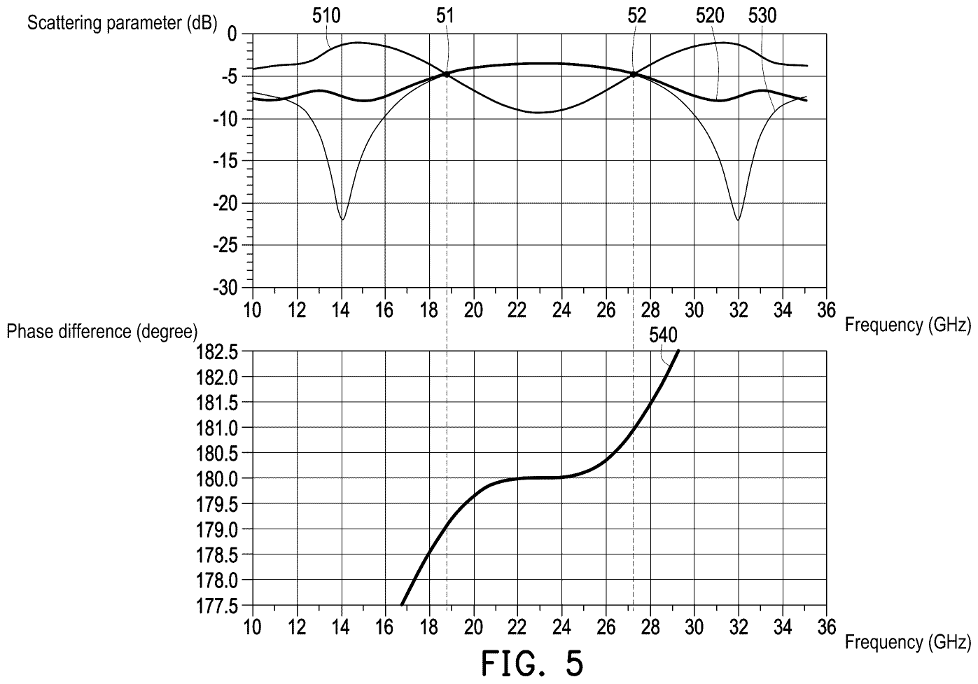

FIG. 5 is a simulation diagram of an S parameter of a second-order rat-race coupler with n=0.5 (for example, the rat-race coupler 200 with the strip-shaped conductors 23 and 24 of electrical length ¼) according to an embodiment of the disclosure, in which a plot 510 represents an S parameter S₁₁ (that is, the input reflection coefficient or return loss of the port P1), a plot 520 represents an S parameter S₂₁ (that is, the insertion loss of a signal transmitted from the port P1 to the port P2), a plot 530 represents an S parameter S₃₁ (that is, the insertion loss of a signal transmitted from the port P1 to the port P3), a plot 540 represents the phase difference between the port P2 and the port P3, and points 51 and 52 are the intersection points of the three plots at −5 dB. Referring to the points 51 and 52, the efficient operating bandwidth of the second-order rat-race coupler is approximately between 18.5 GHz-27.5 GHz, and the phase error is only approximately 1 degree.

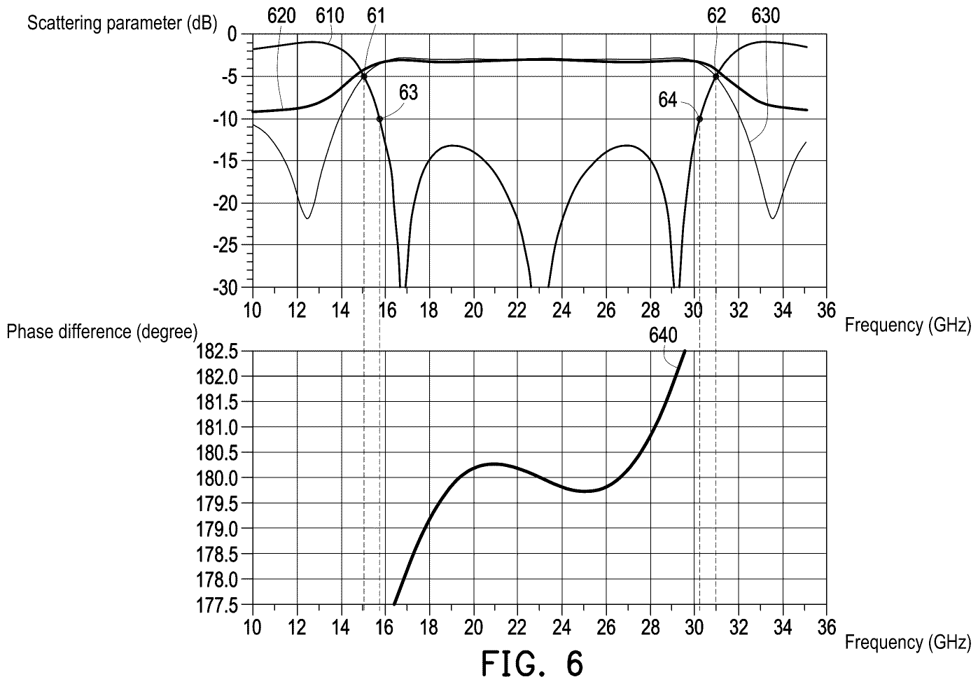

FIG. 6 is a simulation diagram of the S parameter of the second-order rat-race coupler with n=1 (for example, the rat-race coupler 200 with the strip-shaped conductors 23 and 24 of electrical length ½) according to an embodiment of the disclosure, in which a plot 610 represents the S parameter S₁₁, a plot 620 represents the S parameter S₂₁, a plot 630 represents the S parameter S₃₁, a plot 640 represents the phase difference between the port P2 and the port P3, points 61 and 62 are the intersection points of the three plots at −5 dB, and points 63 and 64 are the values of the plot 610 at −10 dB. Referring to the points 61 and 62, the efficient operating bandwidth of the second-order rat-race coupler is approximately between 15 GHz-31 GHz, and the phase error is only approximately 2.5 degrees. Referring to the points 63 and 64, in the frequency band 15.5 GHZ-30.5 GHZ, the S-parameter Si of the second-order rat-race coupler shows favorable gain characteristics.

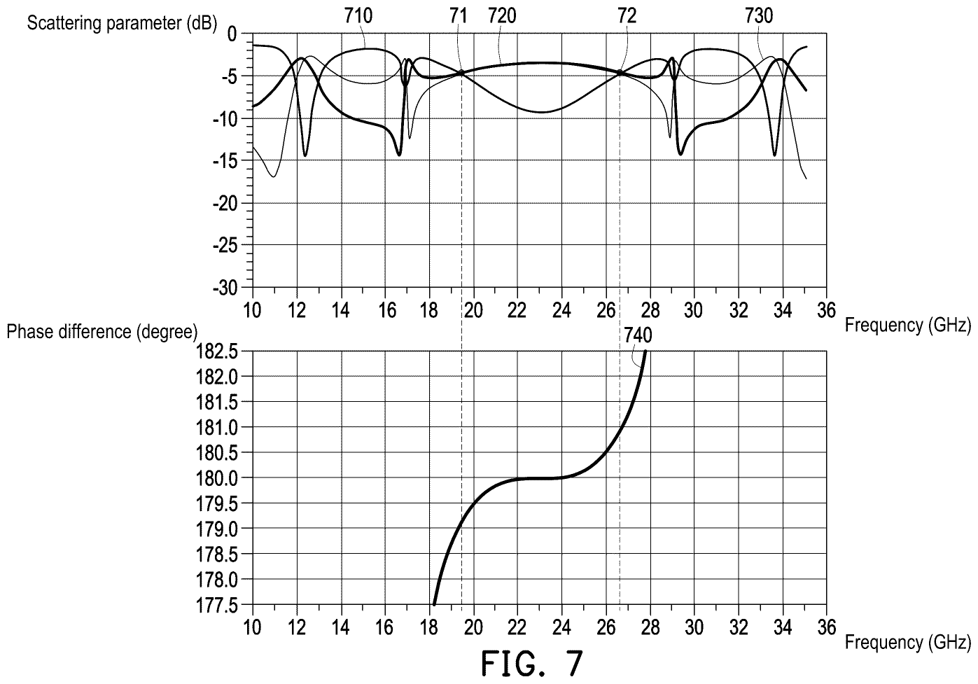

FIG. 7 is a simulation diagram of the S parameter of the second-order rat-race coupler with n=1.5 (for example, the rat-race coupler 200 with the strip-shaped conductors 23 and 24 of electrical length ¾) according to an embodiment of the disclosure, in which a plot 710 represents the S parameter S₁₁, a plot 720 represents the S parameter S₂₁, a plot 730 represents the S parameter S₃₁, a plot 740 represents the phase difference between the port P2 and the port P3, and points 71 and 72 the intersection points of the three plots at −5 dB. Referring to the points 71 and 72, the efficient operating bandwidth of the second-order rat-race coupler is approximately between 19.5 GHz-26.5 GHz, and the phase error is only approximately 2.5 degrees.

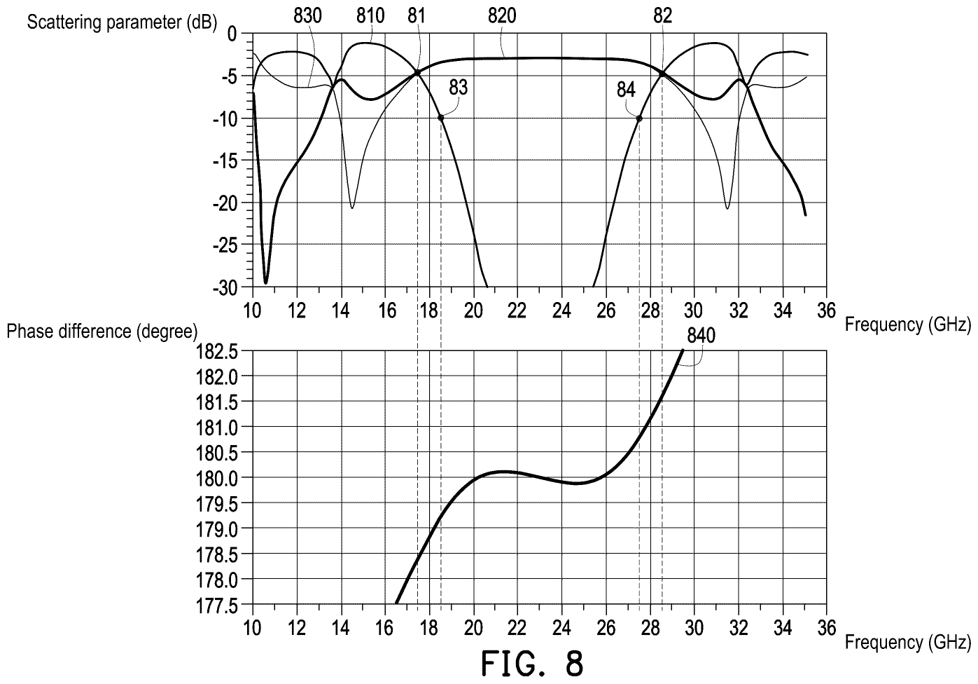

FIG. 8 is a simulation diagram of the S parameters of the second-order rat-race coupler with n=2 (for example, the rat-race coupler 200 with the strip-shaped conductors 23 and 24 of electrical length 1) according to an embodiment of the disclosure, in which a plot 810 represents the S parameter S₁₁, a plot 820 represents the S parameter S₂₁, a plot 830 represents the S parameter S₃₁, a plot 840 represents the phase difference between the port P2 and the port P3, points 81 and 82 are the intersection points of the three plots at −5 dB, and points 83 and 84 are the values of the plot 810 at −10 dB. Referring to the points 81 and 82, the efficient operating bandwidth of the second-order rat-race coupler is approximately between 17.5 GHz-28.5 GHz, and the phase error is only approximately 2 degrees. Referring to the points 83 and 84, in the frequency band 19 GHz-27 GHz, the S-parameter S₁₁ of the second-order rat-race coupler shows favorable gain characteristics.

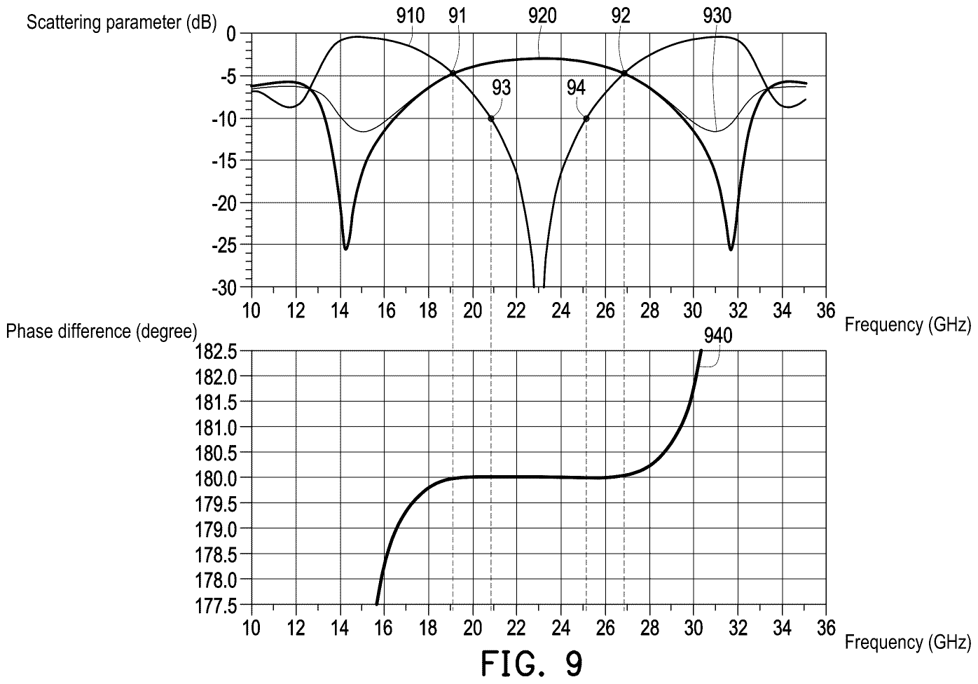

FIG. 9 is a simulation diagram of the S parameter of a third-order rat-race coupler with n=m=0.5 (for example, the rat-race coupler 300 with the strip-shaped conductors 23, 24, 33, and 34 of electrical length ¼) according to an embodiment of the disclosure, in which a plot 910 represents the S parameter S₁₁, a plot 920 represents the S parameter S₂₁, a plot 930 represents the S parameter S₃₁, a plot 940 represents the phase difference between the port P2 and the port P3, points 91 and 92 are the intersection points of the three plots at −5 dB, and points 93 and 94 are the values of the plot 910 at −10 dB. Referring to the points 91 and 92, the efficient operating bandwidth of the third-order rat-race coupler is approximately between 19 GHz-27 GHz, and the phase error is only approximately 0 degrees. Referring to the points 93 and 94, in the frequency band 21 GHz-25 GHz, the S-parameter S₁₁ of the third-order rat-race coupler shows favorable gain characteristics.

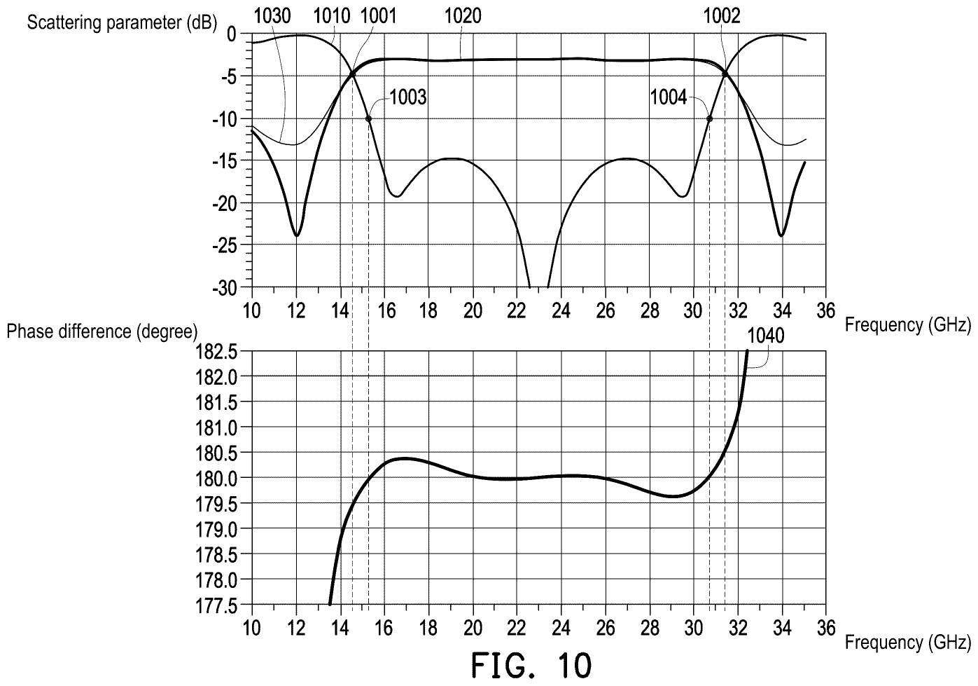

FIG. 10 is a simulation diagram of the S parameter of the third-order rat-race coupler with n=m=1 (for example, the rat-race coupler 300 with the strip-shaped conductors 23, 24, 33, and 34 of electrical length ½) according to an embodiment of the disclosure, in which a plot 1010 represents the S parameter S₁₁, a plot 1020 represents the S parameter S₂₁, a plot 1030 represents the S parameter S₃₁, a plot 1040 represents the phase difference between the port P2 and the port P3, points 1001 and 1002 are the intersection points of the three plots at −5 dB, and points 1003 and 1004 are the values of the plot 1010 at −10 dB. Referring to the points 1001 and 1002, the efficient operating bandwidth of the third-order rat-race coupler is approximately between 14.5 GHZ-31.5 GHz, and the phase error is only approximately 0.5 degrees. Referring to the points 1003 and 1004, in the frequency band 15 GHz-31 GHZ, the S-parameter S₁₁ of the third-order rat-race coupler shows favorable gain characteristics.

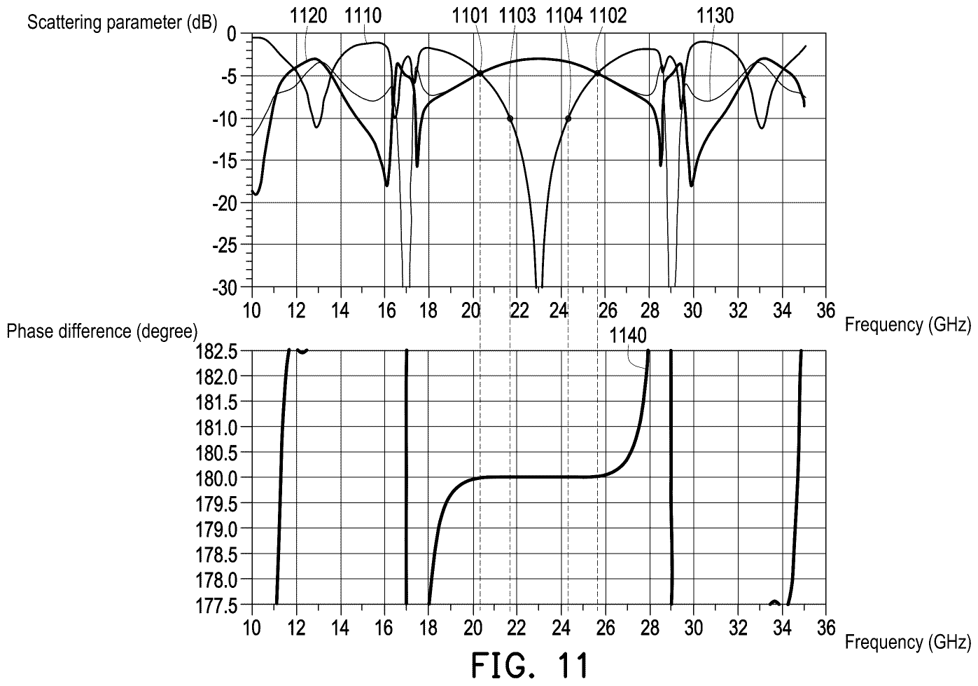

FIG. 11 is a simulation diagram of the S parameter of the third-order rat-race coupler with n=m=1.5 (for example, the rat-race coupler 300 with the strip-shaped conductors 23, 24, 33, and 34 of electrical length ¾) according to an embodiment of the disclosure, in which a plot 1110 represents the S parameter S₁₁, a plot 1120 represents the S parameter S₂₁, a plot 1130 represents the S parameter S₃₁, a plot 1140 represents the phase difference between the port P2 and the port P3, points 1101 and 1102 are the intersection points of the three plots at −5 dB, and points 1103 and 1104 are the values of the plot 1110 at −10 dB. Referring to the points 1101 and 1102, the efficient operating bandwidth of the third-order rat-race coupler is approximately between 20.5 GHz-25.5 GHz, and the phase error is only approximately 0 degrees. Referring to the points 1103 and 1104, in the frequency band 21.5 GHZ-24.5 GHz, the S-parameter Si of the third-order rat-race coupler shows favorable gain characteristics.

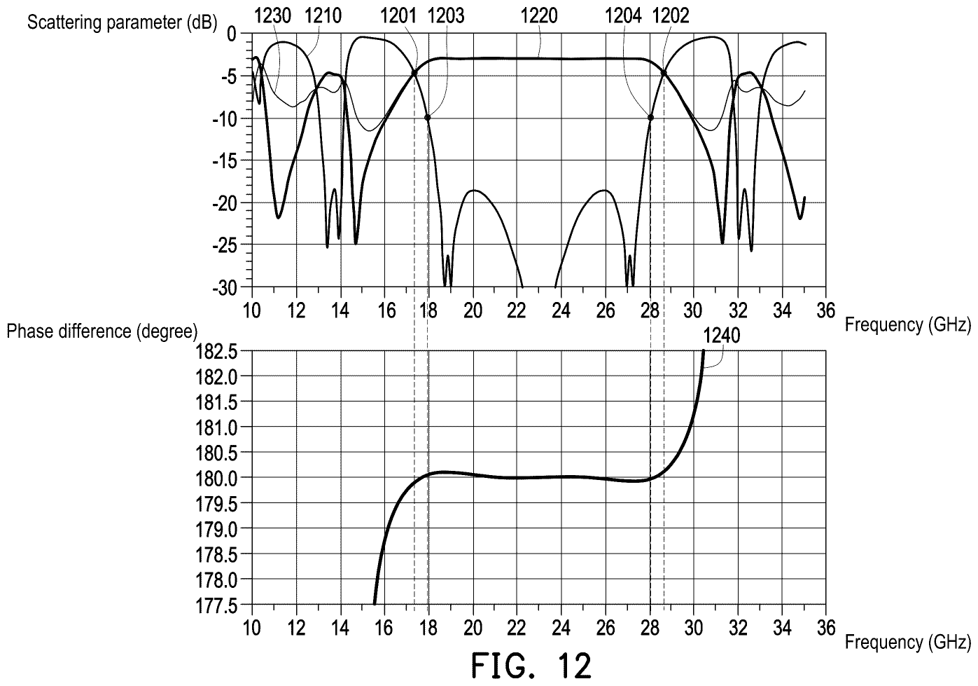

FIG. 12 is a simulation diagram of the S parameter of the third-order rat-race coupler with n=m=2 (for example, the rat-race coupler 300 with the strip-shaped conductors 23, 24, 33, and 34 of electrical length 1) according to an embodiment of the disclosure, in which a plot 1210 represents the S parameter S₁₁, a plot 1220 represents the S parameter S₂₁, a plot 1230 represents the S parameter S₃₁, a plot 1240 represents the phase difference between the port P2 and the port P3, points 1201 and 1202 are the intersection points of the three plots at −5 dB, and points 1203 and 1204 are the values of the plot 1210 at −10 dB. Referring to the points 1201 and 1202, the efficient operating bandwidth of the third-order rat-race coupler is approximately between 17 GHz-29 GHz, and the phase error is only approximately 0 degrees. Referring to the points 1203 and 1204, in the frequency band 18 GHz-28 GHz, the S-parameter Si of the third-order rat-race coupler shows favorable gain characteristics.

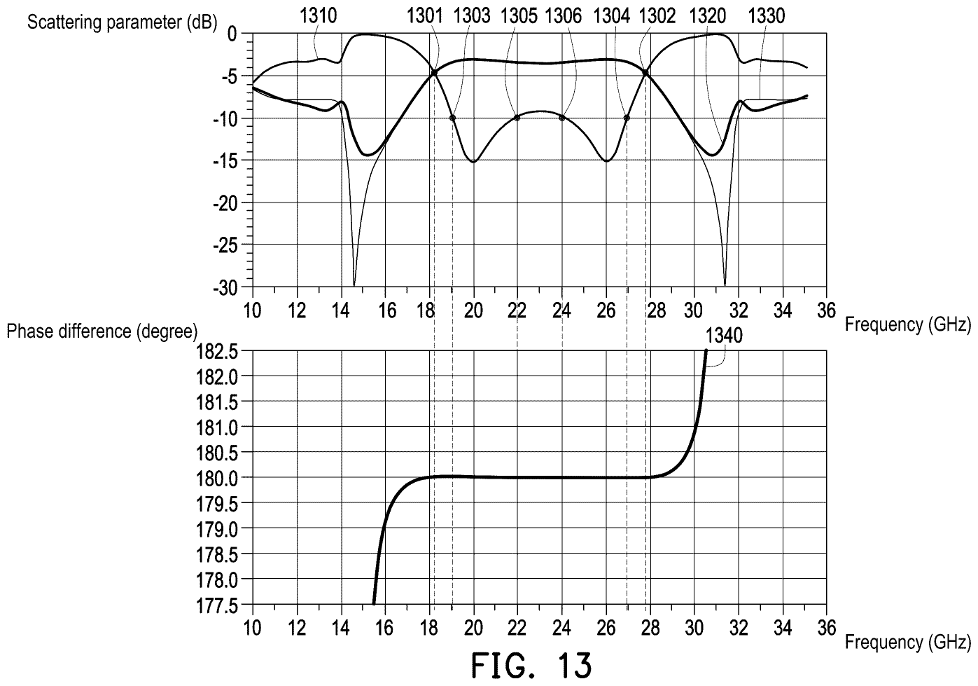

FIG. 13 is a simulation diagram of the S parameter of a fourth-order rat-race coupler with n=m=k=0.5 (for example, the rat-race coupler 400 with the strip-shaped conductors 23, 24, 33, 34, 43, and 44 of electrical length ¼) according to an embodiment of the disclosure, in which a plot 1310 represents the S parameter S₁₁, a plot 1320 represents the S parameter S₂₁, a plot 1330 represents the S parameter S₃₁, a plot 1340 represents the phase difference between the port P2 and the port P3, points 1301 and 1302 are the intersection points of the three plots at −5 dB, and point 1303, point 1304, point 1305, and point 1306 are the values of the plot 1310 at −10 dB. Referring to the points 1301 and 1302, the efficient operating bandwidth of the fourth-order rat-race coupler is approximately between 18.5 GHz-27.5 GHz, and the phase error is only approximately 0 degrees. Referring to the points 1303, 1304, 1305, and 1306, in the frequency band 19 GHz-22 GHz and the frequency band 24 GHz-27 GHz, the S parameter S₁₁ of the fourth-order rat-race coupler shows favorable gain characteristics.

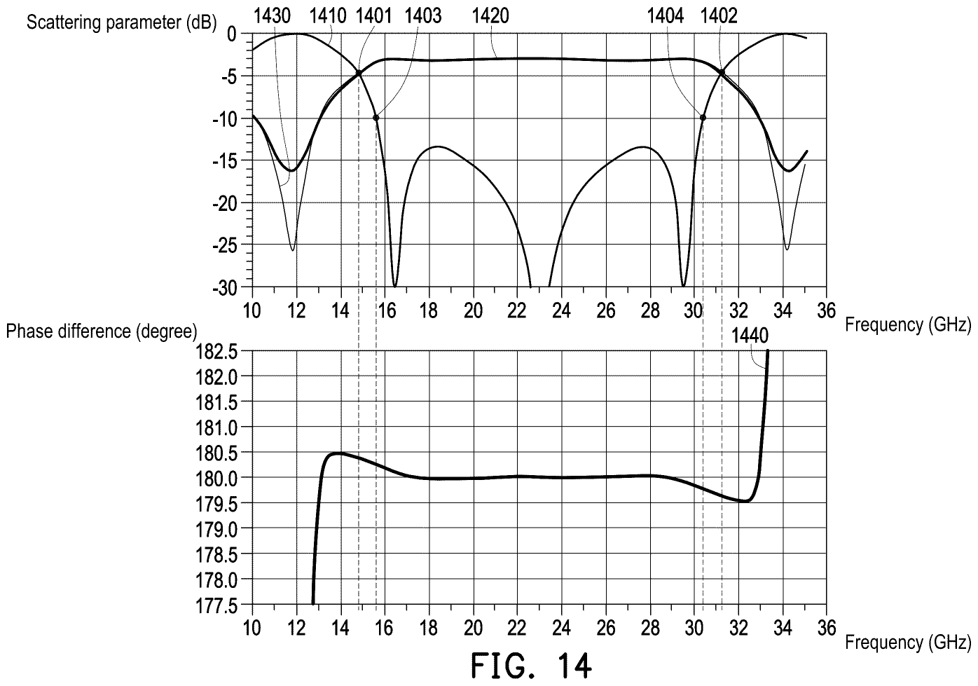

FIG. 14 is a simulation diagram of the fourth-order rat-race coupler with n=m=k=1 (for example, the rat-race coupler 400 with the strip-shaped conductors 23, 24, 33, 34, 43, and 44 of electrical length ½) according to an embodiment of the disclosure, in which a plot 1410 represents the S parameter S₁₁, a plot 1420 represents the S parameter S₂₁, a plot 1430 represents the S parameter S₃₁, a plot 1440 represents the phase difference between the port P2 and the port P3, points 1401 and 1402 are the intersection points of the three plots at −5 dB, and points 1403 and 1404 are the values of the plot 1410 at −10 dB. Referring to the points 1401 and 1402, the efficient operating bandwidth of the fourth-order rat-race coupler is approximately between 15 GHz-31 GHz, and the phase error is only approximately 0.5 degrees. Referring to points 1403 and 1404, in the frequency band 15.5 GHZ-30.5 GHZ, the S-parameter S₁₁ of the fourth-order rat-race coupler shows favorable gain characteristics.

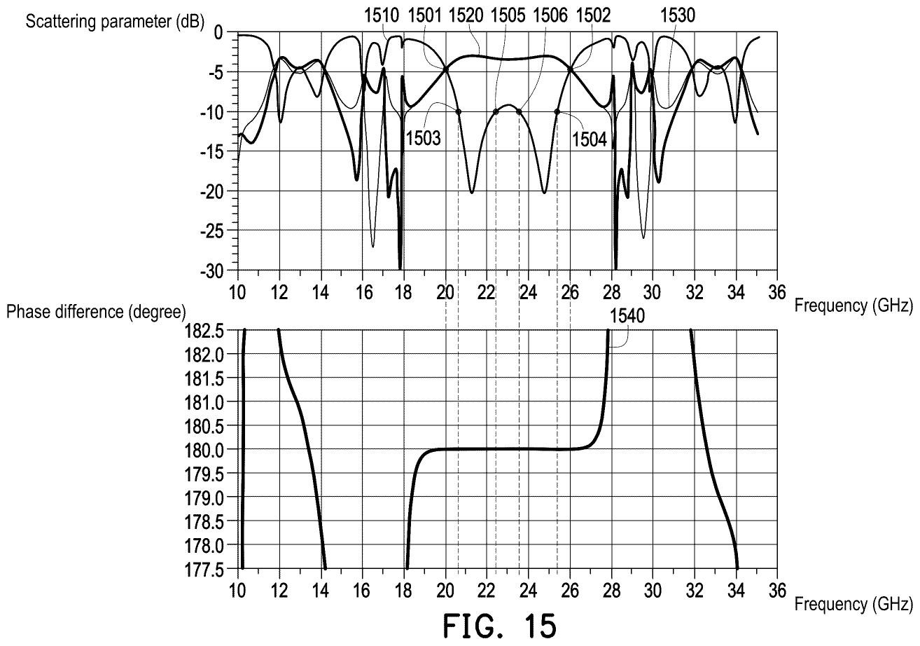

FIG. 15 is a simulation diagram of the S parameter of the fourth-order rat-race coupler with n=m=k=1.5 (for example, the rat-race coupler 400 with the strip-shaped conductors 23, 24, 33, 34, 43, and 44 of electrical length ¾) according to an embodiment of the disclosure, in which a plot 1510 represents the S parameter S₁₁, a plot 1520 represents the S parameter S₂₁, a plot 1530 represents the S parameter S₃₁, a plot 1540 represents the phase difference between the port P2 and the port P3, points 1501 and 1502 are the intersection points of the three plots at −5 dB, and point 1503, point 1504, point 1505, and point 1506 are the values of the plot 1510 at −10 dB. Referring to the points 1501 and 1502, the efficient operating bandwidth of the fourth-order rat-race coupler is approximately between 20 GHz-26 GHz, and the phase error is only approximately 0 degrees. Referring to the points 1503, 1504, 1505, and 1506, in the frequency band 20.5 GHz-22.5 GHz and the frequency band 23.5 GHz-25.5 GHZ, the S parameter S₁₁ of the fourth-order rat-race coupler shows favorable gain characteristics.

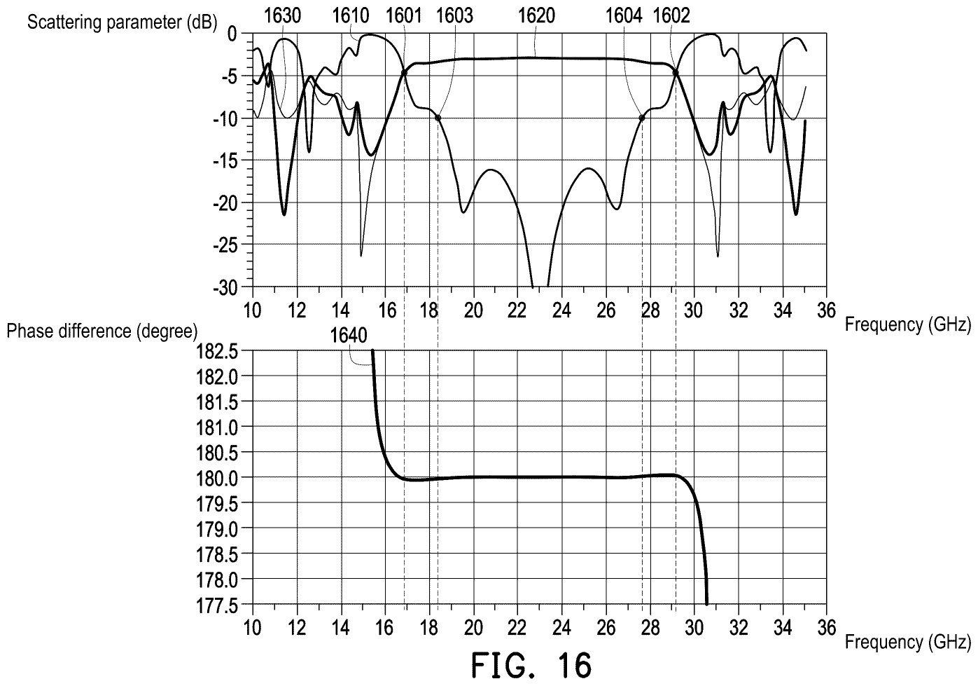

FIG. 16 is a simulation diagram of the S parameter of the fourth-order rat-race coupler with n=m=k=2 (for example, the rat-race coupler 400 with the strip-shaped conductors 23, 24, 33, 34, 43, and 44 of electrical length 1) according to an embodiment of the disclosure, in which a plot 1610 represents the S parameter S₁₁, a plot 1620 represents the S parameter S₂₁, a plot 1630 represents the S parameter S₃₁, a plot 1640 represents the phase difference between the port P2 and the port P3, points 1601 and 1602 are the intersection points of the three plots at −5 dB, and points 1603 and 1604 are the values of the plot 1610 at −10 dB. Referring to the points 1601 and 1602, the efficient operating bandwidth of the fourth-order rat-race coupler is approximately between 16.5 GHZ-30.5 GHz, and the phase error is only approximately 0 degrees. Referring to the points 1603 and 1604, in the frequency band 18.5 GHZ-29 GHz, the S-parameter Su of the fourth-order rat-race coupler shows favorable gain characteristics.

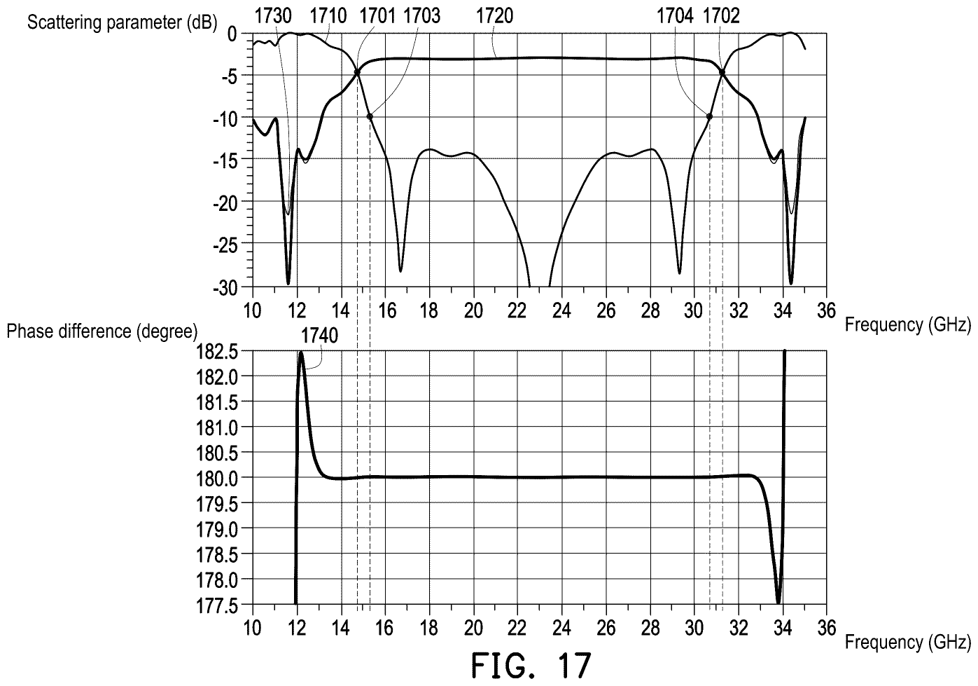

FIG. 17 is a simulation diagram of the S parameter of a seventh-order rat-race coupler with n=m=k=1 according to an embodiment of the disclosure, in which a plot 1710 represents the S parameter S₁₁, a plot 1720 represents the S parameter S₂₁, a plot 1730 represents the S parameter S₃₁, a plot 1740 represents the phase difference between the port P2 and the port P3, points 1701 and 1702 are the intersection points of the three plots at −5 dB, and points 1703 and 1704 are the values of the plot 1710 at −10 dB. Referring to the points 1701 and 1702, the efficient operating bandwidth of the seventh-order rat-race coupler is approximately between 14.5 GHz-31.5 GHz, and the phase error is only approximately 0 degrees. Referring to the points 1703 and 1704, in the frequency band 15.5 GHz-30.5 GHz, the S-parameter Su of the seventh-order rat-race coupler shows favorable gain characteristics. It may be seen from FIG. 13 to FIG. 17 that compared with the fourth-order rat-race coupler, the gain and phase error of the seventh-order rat-race coupler in the efficient operating bandwidth are not significantly improved. Therefore, users may consider using a lower-cost fourth-order rat-race coupler to replace the seventh-order rat-race coupler when designing circuits.

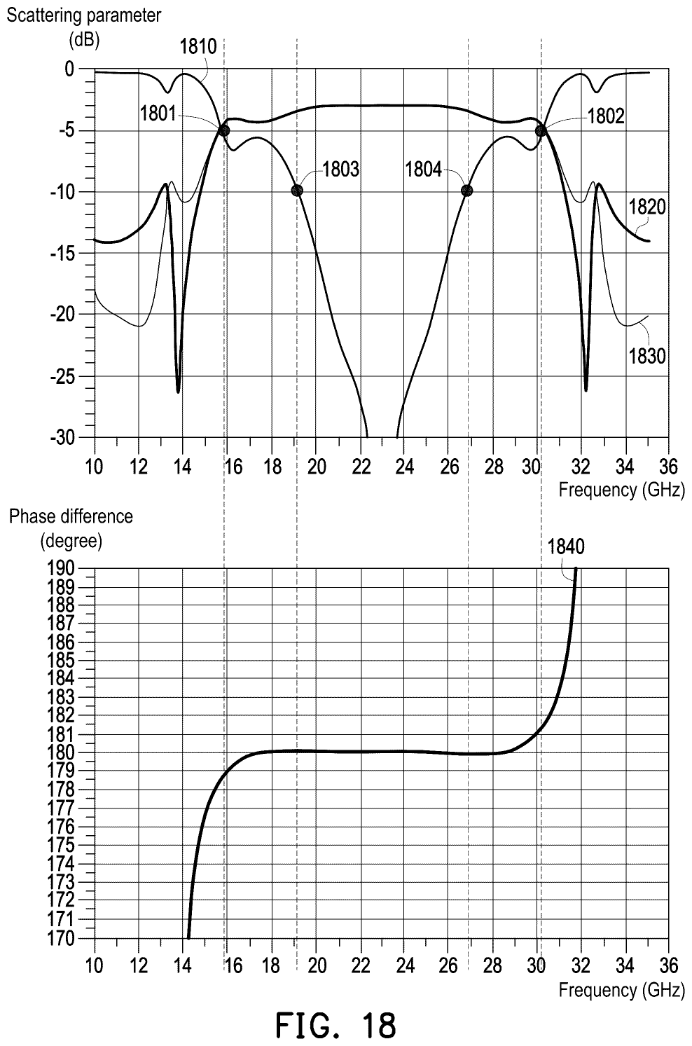

FIG. 18 is a simulation diagram of the S parameter of the third-order rat-race coupler with n=1 and m=2 (for example, the rat-race coupler 300 with the strip-shaped conductors 23, 24 of electrical length ½ and the strip-shaped conductors 33, 34 of electrical length 1) according to an embodiment of the disclosure, in which a plot 1810 represents the S parameter S₁₁, a plot 1820 represents the S parameter S₂₁, a plot 1830 represents the S parameter S₃₁, a plot 1840 represents the phase difference between the port P2 and the port P3, points 1801 and 1802 are the intersection points of the three plots at −5 dB, and points 1803 and 1804 are the values of the plot 1810 at −10 dB. Referring to the points 1801 and 1802, the efficient operating bandwidth of the third-order rat-race coupler is approximately between 16 GHz-30 GHz, and the phase error is only approximately 0 degrees. Referring to the points 1803 and 1804, in the frequency band 19 GHz-27 GHz, the S-parameter S₁₁ of the third-order rat-race coupler shows favorable gain characteristics.

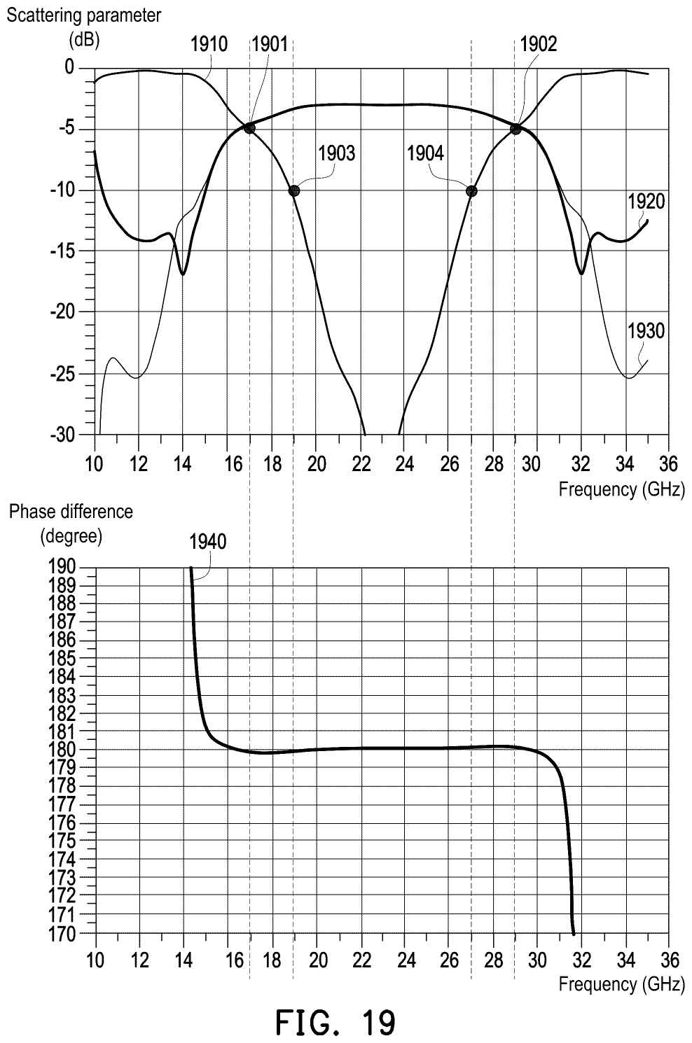

FIG. 19 is a simulation diagram of the S parameter of the third-order rat-race coupler with n=2 and m=1 (for example, the rat-race coupler 300 with the strip-shaped conductors 23, 24 of electrical length 1 and the strip-shaped conductors 33, 34 of electrical length ½) according to an embodiment of the disclosure, in which a plot 1910 represents the S parameter S₁₁, a plot 1920 represents the S parameter S₂₁, a plot 1930 represents the S parameter S₃₁, a plot 1940 represents the phase difference between the port P2 and the port P3, points 1901 and 1902 are the intersection points of the three plots at −5 dB, and points 1903 and 1904 are the values of the plot 1910 at −10 dB. Referring to the points 1901 and 1902, the efficient operating bandwidth of the third-order rat-race coupler is approximately between 17 GHz-29 GHz, and the phase error is only approximately 0 degrees. Referring to the points 1903 and 1904, in the frequency band 19 GHz-27 GHz, the S-parameter S₁₁ of the third-order rat-race coupler shows favorable gain characteristics.

Based on the contents of FIG. 5 to FIG. 16 and FIG. 18 to FIG. 19, it can be seen that when the electrical length of the strip-shaped conductors 23, 24, 33, 34, 43 meets the specific criterion, in addition to the advantage of extremely small phase error, the range of the efficient operating bandwidth that the rat-race coupler can cope with is also wider. Specifically, when n, m or k is an even number, the rat-race coupler provided by the disclosure can take into account both low phase error and a wide range of efficient operating bandwidth.

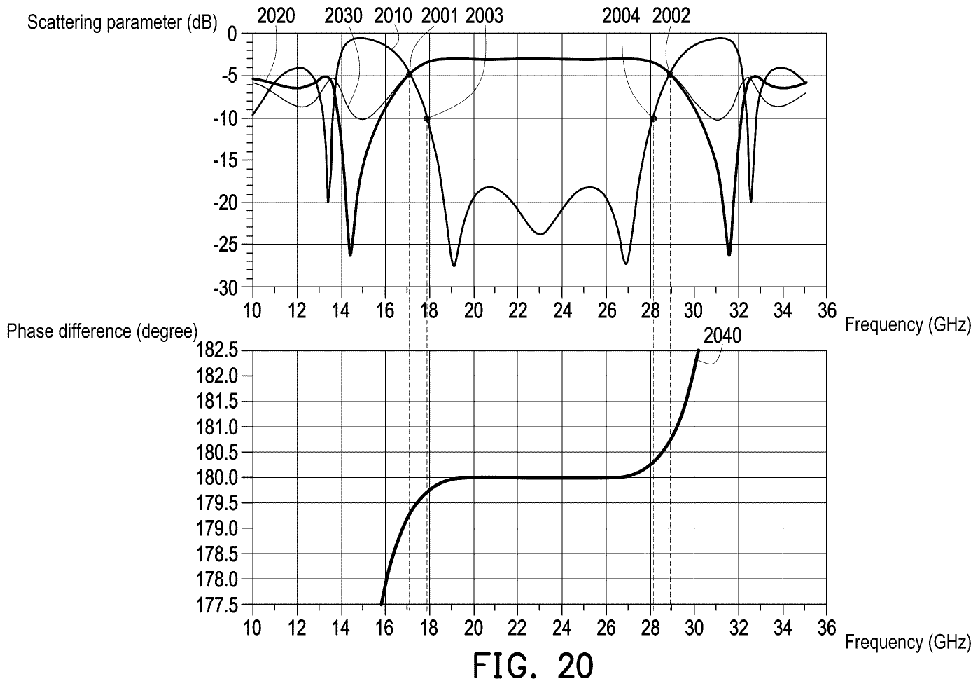

It is worth noting that the impedance of each conductor in the rat-race coupler (for example, 100, 200, 300, or 400) may be adjusted by the user according to needs, and is not limited by the disclosure. Taking the third-order rat-race coupler 300 as an example, in an embodiment, in the annular-shaped conductor #1 of the rat-race coupler 300, the impedance of the strip-shaped conductor 11 may be 70 Ohms, the impedance of the strip-shaped conductor 12 may be 30 Ohms, and the impedances of the strip-shaped conductor 13 and the strip-shaped conductor 14 may be 60 Ohms. In the bandwidth adjustment part #2, the impedance of the strip-shaped conductor 22 may be 35 Ohms, and the impedances of the strip-shaped conductor 23 and the strip-shaped conductor 24 may be 77 Ohms. In the bandwidth adjustment part #3, the impedance of the strip-shaped conductor 32 may be 40 Ohms, and the impedances of the strip-shaped conductor 33 and the strip-shaped conductor 34 may be 85 Ohms. The S parameter of the rat-race coupler 300 with the above impedance configuration is shown in FIG. 20.

FIG. 20 is a simulation diagram of the S parameter of the third-order rat-race coupler 300 with n=m=0.5 according to an embodiment of the disclosure, in which a plot 2010 represents the S parameter S₁₁, a plot 2020 represents the S parameter S₂₁, a plot 2030 represents the S parameter S₃₁, a plot 2040 represents the phase difference between the port P2 and the port P3, points 2001 and 2002 are the intersection points of the three plots at −5 dB, and points 2003 and 2004 are the values of the plot 2010 at −10 dB. Referring to the points 2001 and 2002, the efficient operating bandwidth of the rat-race coupler 300 is approximately between 17.2 GHz-28.8 GHz, and the phase error is only approximately 0.4 degrees. Referring to the points 2003 and 2004, in the frequency band 18 GHz-28 GHz, the S-parameter Su of the rat-race coupler 300 shows favorable gain characteristics.

In summary, the disclosure combines the annular-shaped conductor and the one or more bandwidth adjustment parts to form the multi-order rat-race coupler, and the bandwidth adjustment part may include the strip-shaped conductor with a specific length. Compared with the conventional rat-race coupler, the two output signals of the rat-race coupler of the disclosure have smaller phase errors.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A rat-race coupler, comprising:
an annular-shaped conductor, comprising:
a first strip-shaped conductor, has a first terminal and a second terminal;
a second strip-shaped conductor, has a third terminal and a fourth terminal;
a third strip-shaped conductor; and
a fourth strip-shaped conductor;
wherein the first terminal is connected to the third terminal through the third strip-shaped conductor, the second terminal is connected to the fourth terminal through the fourth strip-shaped conductor;
a first bandwidth adjustment part, comprising:
a fifth strip-shaped conductor;
a sixth strip-shaped conductor; and
a seventh strip-shaped conductor, has a fifth terminal and a sixth terminal;
wherein the fifth terminal is connected to the third terminal through the fifth strip-shaped conductor, the sixth terminal is connected to the fourth terminal through the sixth strip-shaped conductor;
a first port, is connected to the fifth terminal;
a second port, is connected to the first terminal; and
a third port, is connected to the second terminal;
wherein an electrical length from the first terminal through the first strip-shaped conductor to the second terminal, an electrical length from the third terminal through the second strip-shaped conductor to the fourth terminal, and an electrical length from the fifth terminal through the seventh strip-shaped conductor to the sixth terminal are both ½;
wherein an electrical length from the first terminal through the third strip-shaped conductor to the third terminal, and an electrical length from the second terminal through the fourth strip-shaped conductor to the fourth terminal are both ¼;
wherein an electrical length from the third terminal through the fifth strip-shaped conductor to the fifth terminal, and an electrical length from the fourth terminal through the sixth strip-shaped conductor to the sixth terminal are both n/4, wherein n is a positive integer.

2. The rat-race coupler according to claim 1, wherein n is an even number.

3. The rat-race coupler according to claim 1, further comprising:
a fourth port, is connected to a center of the first strip-shaped conductor.

4. The rat-race coupler according to claim 1, wherein the first port, the second port, and the third port are used to connect to at least one external system, the at least one external system has a load impedance, an impedance of the second strip-shaped conductor is 1.2 times the load impedance, an impedance of the seventh strip-shaped conductor is 0.8 times the load impedance, and an impedance of the fifth strip-shaped conductor and an impedance of the sixth strip-shaped conductor are both 2.8 times the load impedance.

5. The rat-race coupler according to claim 1, further comprising:
a second bandwidth adjustment part, comprising:
an eighth strip-shaped conductor;
a ninth strip-shaped conductor; and
a tenth strip-shaped conductor, has a seventh terminal and an eighth terminal;
wherein the seventh terminal is connected to the fifth terminal through the eighth strip-shaped conductor, the eighth terminal is connected to the sixth terminal through the ninth strip-shaped conductor;
wherein the first port is connected to the seventh terminal, and is connected to the fifth terminal through the eighth strip-shaped conductor.

6. The rat-race coupler according to claim 5, wherein the first port, the second port, and the third port are used to connect to at least one external system, the at least one external system has a load impedance, wherein an impedance of the tenth strip-shaped conductor is 0.8 times the load impedance, an impedance of the seventh strip-shaped conductor is 1.4 times the load impedance, an impedance of the sixth strip-shaped conductor, an impedance of the eighth strip-shaped conductor, and an impedance of the ninth strip-shaped conductor are both 2.8 times the load impedance.

7. The rat-race coupler according to claim 5, wherein an electrical length from the seventh terminal through the tenth strip-shaped conductor to the eighth terminal is ½, an electrical length from the fifth terminal through the eighth strip-shaped conductor to the seventh terminal and an electrical length from the sixth terminal through the ninth strip-shaped conductor to the eighth terminal are both m/2, wherein m is a positive integer.

8. The rat-race coupler according to claim 7, wherein m is an even number.

9. The rat-race coupler according to claim 7, wherein m is equal to n.

10. The rat-race coupler according to claim 5, further comprising:
a third bandwidth adjustment part, comprising:
an eleventh strip-shaped conductor;
a twelfth strip-shaped conductor; and
a thirteenth strip-shaped conductor, has a ninth terminal and a tenth terminal;
wherein the ninth terminal is connected to the seventh terminal through the eleventh strip-shaped conductor, the tenth terminal is connected to the eighth terminal through the twelfth strip-shaped conductor;
wherein the first port is connected to the ninth terminal, and is connected to the fifth terminal through the eleventh strip-shaped conductor and the eighth strip-shaped conductor.

11. The rat-race coupler according to claim 10, wherein the first port, the second port, and the third port are used to connect to at least one external system, the at least one external system has a load impedance, wherein an impedance of the seventh strip-shaped conductor and an impedance of the tenth strip-shaped conductor are both 1.4 times the load impedance, an impedance of the thirteenth strip-shaped conductor is 0.8 times the load impedance, an impedance of the fifth strip-shaped conductor, an impedance of the sixth strip-shaped conductor, an impedance of the eighth strip-shaped conductor, an impedance of the ninth strip-shaped conductor, an impedance of the eleventh strip-shaped conductor and an impedance of the twelfth strip-shaped conductor are both 2.8 times the load impedance.

12. The rat-race coupler according to claim 10, wherein an electrical length from the ninth terminal through the thirteenth strip-shaped conductor to the tenth terminal is ½, and an electrical length from the seventh terminal through the eleventh strip-shaped conductor to the ninth terminal and an electrical length from the eighth terminal through the twelfth strip-shaped conductor to the tenth terminal are both k/2, wherein k is a positive integer.

13. The rat-race coupler according to claim 12, wherein k is an even number.

14. The rat-race coupler according to claim 12, k, m and n are equal.
